(19) United States
(12) Patent Application Publication
(10) Pub. No.: US 2026/0299330 A1
(43) Pub. Date: Oct. 1, 2026

(54) OPTICAL WAVEGUIDE DEVICE AND OPTICAL MODULATION DEVICE AND OPTICAL TRANSMISSION APPARATUS USING THE SAME

(71) Applicant: SUMITOMO OSAKA CEMENT CO., LTD., Tokyo (JP)

(72) Inventors: Junji Arai, Tokyo (JP); Kosuke Okahashi, Tokyo (JP)

(73) Assignee: SUMITOMO OSAKA CEMENT CO., LTD., Tokyo (JP)

(21) Appl. No.: 19/283,246

(22) Filed: Jul. 29, 2025

(30) Foreign Application Priority Data
Mar. 28, 2025 (JP) 2025-054994

(51) Int. Cl. G02F 1/035; G02F 1/21

(52) U.S. Cl. CPC G02F 1/035; G02F 1/212

(57) ABSTRACT

An optical waveguide device achieves both improvement of electric field efficiency and suppression of the pyroelectric effect.

The optical waveguide device is composed of a ferroelectric material and includes an optical waveguide substrate (1) having an optical waveguide (WG), and control electrodes (E1, E2) that apply an electric field to the optical waveguide, in which the optical waveguide is formed in a part of a convex section (10) formed on a surface of the optical waveguide substrate, a buffer layer (BF) and a charge diffusion layer (CD) that cover the optical waveguide are formed in order, and the control electrodes are disposed in contact with the optical waveguide substrate.

### CROSS-REFERENCE TO RELATED APPLICATION

This application claims the priority benefits of Japanese application no. 2025-054994, filed on Mar. 28, 2025. The entirety of the above-mentioned patent application is hereby incorporated by reference herein and made a part of this specification.

### BACKGROUND

### Technical Field

The disclosure relates to an optical waveguide device, an optical modulation device using the same, and an optical transmission apparatus, and particularly relates to an optical waveguide device that is composed of a ferroelectric material and includes an optical waveguide substrate having an optical waveguide, and control electrodes that apply an electric field to the optical waveguide, and an optical modulation device and optical transmission apparatus using the same.

### Description of Related Art

In the optical communication field and optical measurement field, optical waveguide devices using ferroelectric materials such as lithium niobate as substrates are widely used. Optical waveguide devices such as optical modulators are required to be miniaturized and have wider bandwidths, and control electrodes are disposed in proximity to optical waveguides to reduce driving voltages. However, in the case of disposing control electrodes in proximity to optical waveguides, optical waves propagating through the optical waveguides are absorbed and scattered by the metal materials constituting the electrodes, causing an increase in optical propagation loss.

In Patent Literature 1 (Japanese Patent Application Laid-Open No. 10-3064) or Patent Literature 2 (Japanese Patent Application Laid-Open No. 2022-189578), a buffer layer is provided between the optical waveguide and the electrode to suppress absorption of optical waves by the electrode. However, in the case of a buffer layer being interposed between the optical waveguide and the electrode, the distance between the optical waveguide and the electrode increases, and another dielectric material is interposed, resulting in reduced efficiency of the electric field applied to the optical waveguide by the electrode.

The reduction in the electric field effect is more pronounced in the case of disposing electrodes to sandwich the optical waveguide as in Patent Literature 2 (for example, X-cut substrate) than the reduction in electric field efficiency in the case of disposing electrodes above the optical waveguide as in Patent Literature 1 (for example, Z-cut substrate).

On the other hand, in optical waveguide substrates using ferroelectric materials, charge generation (pyroelectric effect) occurs on the surface of the substrate, such as the DC drift phenomenon and temperature drift phenomenon. Such charge generation causes unneeded electric fields to be applied to the optical waveguide, making optical control by the control electrode more complex.

Patent Literature 1 or Patent Literature 2 discloses forming an antistatic film (charge diffusion layer) of a Si layer to cover the buffer layer between the buffer layer and the electrode. In this case, the charge diffusion layer is interposed between the optical waveguide and the electrode, resulting in a larger spacing between the optical waveguide and the electrode and causing a reduction in electric field efficiency. Also, in Patent Literature 1 or Patent Literature 2, the charge diffusion layer being interposed between the electrodes prevents a proper voltage from being applied to the electrodes, which also causes a reduction in the electric field efficiency applied to the optical waveguide.

The disclosure provides an optical waveguide device that achieves both improvement of electric field efficiency and suppression of the pyroelectric effect. Furthermore, the disclosure provides an optical modulation device and an optical transmission apparatus using such an optical waveguide device.

### SUMMARY

The optical waveguide device of the disclosure and the optical modulation device and optical transmission apparatus using the same have the following technical characteristics.
(1) An optical waveguide device is composed of a ferroelectric material and includes an optical waveguide substrate having an optical waveguide, and control electrodes that apply an electric field to the optical waveguide, in which the optical waveguide is formed in a part of a convex section formed on a surface of the optical waveguide substrate, a buffer layer and a charge diffusion layer that cover the optical waveguide are formed in order, and the control electrodes are disposed in contact with the optical waveguide substrate.
(2) In the optical waveguide device described in (1) above, the buffer layer and the charge diffusion layer that cover the optical waveguide are disposed so as to cover at least a part of the control electrode.
(3) In the optical waveguide device described in (1) above, the control electrode is disposed on another convex section adjacent to the optical waveguide.
(4) In the optical waveguide device described in (1) above, the control electrode is composed of a first electrode part having a thin thickness and a second electrode part having a thick thickness.
(5) In the optical waveguide device described in (1) above, a resin layer covering at least a part of the charge diffusion layer is formed.
(6) In the optical waveguide device described in (1) above, the optical waveguide includes multiple Mach-Zehnder optical waveguides, and at least a part between the adjacent Mach-Zehnder optical waveguides has a portion in which the surface of the optical waveguide substrate is exposed.
(7) In the optical waveguide device described in (1) above, a thickness of the charge diffusion layer is set within a range of 50 nm or more and 500 nm or less.
(8) In the optical waveguide device described in (1) above, a thickness of the buffer layer is set within a range of 200 nm or more and 3000 nm or less.
(9) In the optical waveguide device described in (1) above, a volume resistivity of the charge diffusion layer is set within a range of 10⁸ Ω·cm or more and 10¹⁴ Ω·cm or less.
(10) An optical modulation device includes the optical waveguide device described in any one of (1) to (9) above that is accommodated in a housing and an optical fiber that inputs or outputs a light wave to the optical waveguide.
(11) In the optical modulation device described in (10) above, the optical waveguide device has a modulation electrode for modulating a light wave propagating through the optical waveguide, and an electronic circuit that amplifies a modulation signal input to the modulation electrode is provided inside the housing.
(12) An optical transmission apparatus includes the optical modulation device described in (10) above and an electronic circuit that outputs a modulation signal to the optical modulation device.

### BRIEF DESCRIPTION OF THE DRAWINGS

FIG. 1 is a cross-sectional view showing an example of the optical waveguide device of the disclosure.

FIGS. 2A and 2B are plan views describing the shape of a control electrode used in the optical waveguide device of the disclosure, with FIG. 2A showing a linear electrode and FIG. 2B showing a segment electrode.

FIG. 3 is a cross-sectional view showing another example of the optical waveguide device of the disclosure.

FIGS. 4A to 4D are cross-sectional views describing the positional relationship between electrodes and the buffer layer and charge diffusion layer in the optical waveguide device of the disclosure.

FIGS. 5A and 5B are diagrams describing the state below a thick electrode which is a second electrode part in the optical waveguide device of the disclosure.

FIG. 6 is a diagram describing an example of a modulation region and a DC bias region in the optical waveguide device of the disclosure.

FIGS. 7A and 7B are diagrams describing a stress relaxation configuration in the optical waveguide device of the disclosure.

FIG. 8 is a diagram showing an example of the optical transmission apparatus of the disclosure.

### DESCRIPTION OF THE EMBODIMENTS

The disclosure includes an optical waveguide substrate that has an optical waveguide and control electrodes that apply an electric field to the optical waveguide in an optical waveguide device composed of a ferroelectric material, in which the optical waveguide is formed in a part of a convex section formed on a surface of the optical waveguide substrate, a buffer layer and a charge diffusion layer that cover the optical waveguide are formed in order, and the control electrodes are disposed in contact with the optical waveguide substrate. Thus, electric field efficiency may be improved and the pyroelectric effect may be suppressed.

Moreover, an optical modulation device and an optical transmission apparatus using an optical waveguide device having such technical characteristics may be provided.

Hereinafter, an optical waveguide device of the disclosure will be described in detail using exemplary examples.

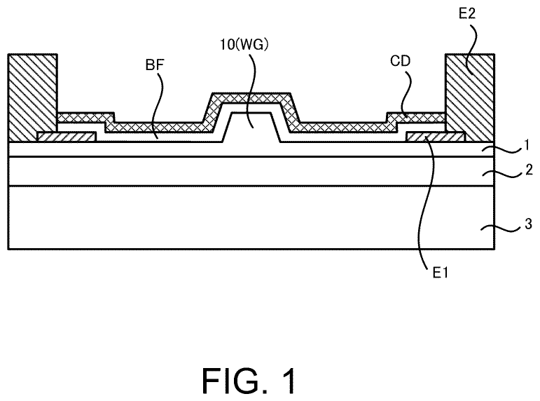

As shown in FIGS. 1, 3 to 5, and 7, the optical waveguide device of the disclosure is composed of a ferroelectric material and includes: an optical waveguide substrate 1 that has an optical waveguide (WG); and control electrodes (E1, E2) that apply an electric field to the optical waveguide, in which the optical waveguide is formed in a part of a convex section (10) formed on a surface of the optical waveguide substrate, a buffer layer (BF) and a charge diffusion layer (CD) that cover the optical waveguide are formed in order, and the control electrodes are disposed in contact with the optical waveguide substrate.

The material of the optical waveguide substrate 1 used in the optical waveguide device of the disclosure is a ferroelectric substrate, and specifically, substrates such as lithium niobate (LN) and lithium tantalate (LT), base materials obtained by doping the substrate materials with magnesium, and further, PLZT, barium titanate (BTO), and lead zirconate titanate (PZT, Pb(Zr,Ti)O₃) can be used. Additionally, vapor-phase growth films made of the materials can also be utilized. The “optical waveguide substrate” of the disclosure is a concept that includes not only a plate-like body obtained by thinly polishing an LN substrate or the like, but also a film body formed by a vapor-phase growth method.

To enhance the mechanical strength of the optical waveguide substrate 1, a holding substrate 3 is disposed below the optical waveguide substrate 1 via an intermediate layer 2. For the holding substrate 3, materials such as silicon substrates, glass, quartz, and the like, as well as SiPh (silicon photonics) circuits can be utilized.

Additionally, for the intermediate layer 2, dielectric materials with a low dielectric constant and refractive index such as SiO₂, Al₂O₃, Ta₂O₅, and the like are used.

The thickness of the holding substrate 3 is set to approximately 300 to 1000 μm to enhance the mechanical strength of the entire substrate including the optical waveguide substrate. Additionally, the intermediate layer 2 is set to a thickness of 2 to 10 μm with SiO₂ or the like to suppress optical absorption to the holding substrate 3.

Ridge-type or rib-type irregularities are formed on the surface of the optical waveguide substrate 1, and an optical waveguide is formed in a part of the convex section (10). The thickness of the optical waveguide substrate 1 is set to 1 μm or less for purposes such as velocity matching between microwaves and light waves of modulation signals. Additionally, by setting the height and width of the optical waveguide (WG) provided on the optical waveguide substrate 1 to 1 μm or less, the light confinement strength can be increased and the curvature of bending of the optical waveguide can be made large (the radius of bending can be made small), which is suitable for miniaturization of the optical waveguide device. Furthermore, in the case of the size of the optical waveguide (height and width of the optical waveguide WG) becoming small, electrodes can be disposed in proximity to the optical waveguide, so the driving voltage of a modulation signal may be reduced and the length of an active section of the optical waveguide related to the modulation operation and DC bias may be shortened, thereby contributing to further miniaturization.

For the buffer layer (BF) that covers the optical waveguide, transparent materials such as SiO₂ and the like can be utilized. The thickness of the buffer layer is set within a range of 200 nm or more and 3000 nm or less. At 200 nm or more, the influence of optical scattering loss due to roughness of the side surfaces of the optical waveguide and optical absorption by the charge diffusion layer may be suppressed. Additionally, in the case of the thickness of the buffer layer becoming too thick, film stress becomes large, which also causes stress-induced drift.

For the charge diffusion layer (CD), metal nitrides such as TiN, AlN, SiN and the like, metal oxides such as In₂O₃, ZnO, SnO₂, CdO and the like, transparent conductive films such as ITO, AZO, ISO, IZO and the like, metal-doped films such as Al-doped ZnO, Ga-doped ZnO, F-doped SnO and the like can be utilized.

The thickness of the charge diffusion layer (CD) is set within a range of 50 nm or more and 500 nm or less. At a thickness of 50 nm or more, a charge diffusion effect of a certain level or more can be obtained. On the other hand, in the case of the thickness of the charge diffusion layer becoming too thick, film stress becomes large, which causes generation of cracks in the film itself and application of stress to the optical waveguide substrate 1.

The volume resistivity of the charge diffusion layer is set within a range of 10⁸ Ω·cm or more and 10¹⁴ Ω·cm or less so that an electric field by an electrode can be applied to the optical waveguide even in the case of being disposed in contact with a part of the control electrode, and so that charges generated on the surface of the optical waveguide substrate due to the pyroelectric effect can be efficiently diffused.

As described above, the material of the charge diffusion layer is configured to efficiently release charges by partially using conductive materials such as metal oxides and metal nitrides. The composition ratio of contained oxygen or nitrogen to contained metal is set within a range of 0.3 or more and 2.5 or less. A metal film alone has reliability issues due to short circuits between electrodes and oxidation accompanying changes over time. Additionally, this is because films with high nitrogen or oxygen content have high resistance values (insulating films) and do not function as conductive films.

An example of physical property values of SiN used as the charge diffusion layer shows a refractive index of 1.9 to 2.3 (wavelength 1550 nm), resistance value of 10⁸ Ω·cm or more and 10¹⁴ Ω·cm or less, and composition N/Si=1.2 to 1.4.

As the control electrode used in the optical waveguide device of the disclosure, a metal with high conductivity such as Au is utilized. The control electrode is disposed in proximity to the optical waveguide (WG), and includes a first electrode part (E1) that applies an electric field to the optical waveguide and a second electrode part (E2) for wiring to supply power to the first electrode part. The first electrode part is a thin electrode, and the thickness is set to 0.2 to 3.0 μm. On the other hand, the second electrode part is a thick electrode, and the thickness is set to 3 to 100 μm.

Since the second electrode part (E2) is formed on the upper side of the charge diffusion layer such as SiN, it is preferable to dispose an adhesion layer of Nb, Ti, Ni, Cr, Al, or the like and form an electrode layer (Au) thereon.

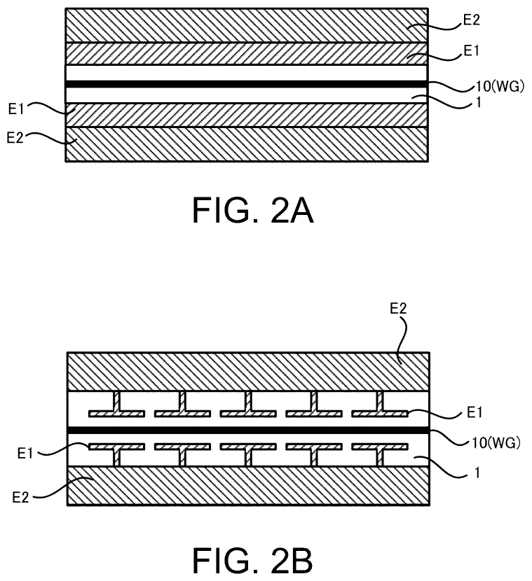

The control electrode includes a modulation electrode (traveling wave electrode) that propagates a modulation signal which is a microwave, and a DC electrode that applies a DC bias voltage. For the first electrode part (E1) of the modulation electrode, it is possible to use not only a linear electrode (E1) along the optical waveguide as shown in FIG. 2A, but also a capacitive loading type segment electrode (E1) as shown in FIG. 2B.

The optical waveguide device of the disclosure includes at least the following two technical characteristics.
(1) The control electrodes (E1, E2) are disposed in contact with the optical waveguide substrate 1.
(2) The optical waveguide is formed in a part of a convex section (10) formed on the surface of the optical waveguide substrate, and a buffer layer (BF) and a charge diffusion layer (CD) that cover the optical waveguide are formed in order.

By directly disposing the control electrodes (E1, E2) on the optical waveguide substrate 1, the optical waveguide and the electrode may be brought closer together, and the decrease in electric field efficiency can be suppressed. In particular, by configuring the control electrode from a thin first electrode part (E1) and a thick second electrode part (E2), and disposing the first electrode part (E1) in proximity to the optical waveguide, electric field concentration can be formed, and improvement in electric field efficiency can be expected.

In the case of forming the buffer layer (BF) and the charge diffusion layer (CD) on the optical waveguide substrate 1, as shown in FIG. 1, the first electrode part (E1) is disposed in contact with the optical waveguide substrate 1, and the buffer layer and the charge diffusion layer are disposed so as to cover the first electrode part (E1).

In the disclosure, in the active section in which the electric field by the control electrode acts on the optical waveguide, the charge diffusion layer (CD) does not really need to be electrically connected to the control electrodes (E1, E2). Naturally, electrical connection is not prevented, but in order to avoid a decrease in the electric field effect, the charge diffusion layer (CD) is configured not to be electrically connected in the vicinity of a tip section of the first electrode part (E1) (the part close to the optical waveguide). Specifically, the charge diffusion layer (CD) is disposed above the first electrode part via the buffer layer (BF).

Even in the case of disposing the charge diffusion layer above the first electrode part (E1) via the buffer layer, by configuring the thickness of the buffer layer to be thin within the numerical range described above, the charges moving in the charge diffusion layer are gradually released to the first electrode part as well, so the role of the charge diffusion layer may be achieved.

Moreover, by disposing the charge diffusion layer via the buffer layer, the electric field generated by the electrode can be made larger compared to the case where the charge diffusion layer directly contacts the electrode. In particular, by excluding direct contact of the charge diffusion layer with the tip section of the first electrode part in which the electric field concentrates, the electric field concentration effect may be further enhanced.

One of the characteristics of the disclosure described above, “The optical waveguide is formed in a part of a convex section (10) formed on the surface of the optical waveguide substrate, and a buffer layer (BF) and a charge diffusion layer (CD) that cover the optical waveguide are formed in order.” will be described.

By forming the optical waveguide in the convex section formed on the surface of the optical waveguide substrate, for example, the Z-axis face of an X-cut LN substrate appears on the side surface of the convex section, and different charges are generated on the side surface. Therefore, by forming the charge diffusion layer so as to cover the convex section that is the optical waveguide, the generated charges can be diffused and the occurrence of the pyroelectric effect can be suppressed.

On the other hand, regarding the parts of the convex section on the surface of the optical waveguide substrate 1 that are not used as the optical waveguide (WG), charges may similarly be generated on the side surfaces of the convex section, so it is preferable to configure so as to cover with the control electrode (particularly the first electrode part (E1)) or the charge diffusion layer (CD). Note that the charge diffusion layer may be disposed directly on the side surface of the convex section or may be disposed via the buffer layer.

As described above, the charge diffusion layer and the electrode do not need to be directly connected. This is because charges escape from the charge diffusion layer to the electrode via the buffer layer.

From the viewpoint of suppressing charge-up, it is effective to configure the buffer layer to be thinner and the charge diffusion layer to be thicker within the numerical range described above.

Charges not only escape to the electrode via the buffer layer, but may also be directly released to the electrode by electrically connecting the charge diffusion layer to a part of the control electrode of the active section or to electrodes other than the active section (wiring part).

Since the charge diffusion layer affects its performance in the case of resistance value changes, it is preferable to use a material that is difficult to oxidize. SiN has very strong barrier performance against moisture and other environmental factors, and is also exemplary in heat resistance and mechanical strength.

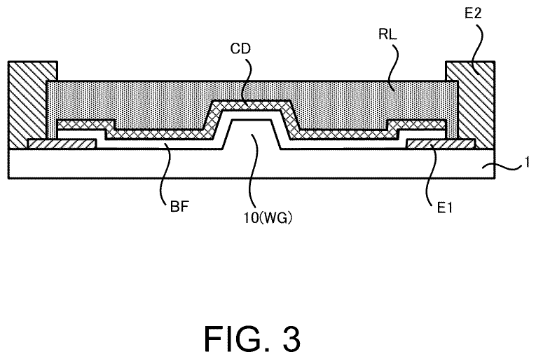

Also, as shown in FIG. 3, by covering the charge diffusion layer (CD) with the resin layer RL, oxidation may be further suppressed. Particularly, in the DC electrode, it is preferable to provide the resin layer RL.

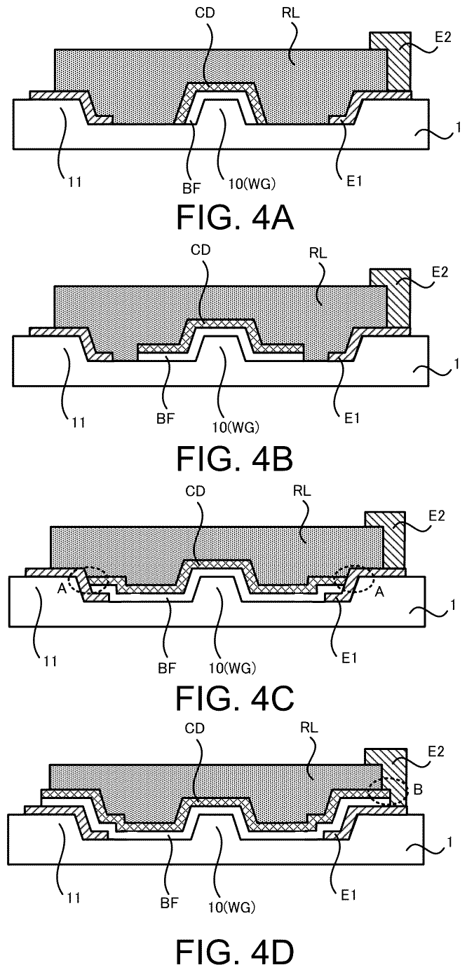

Next, the relationship of the disposition positions of the buffer layer (BF) and charge diffusion layer (CD) with the control electrodes (E1, E2) will be described using FIGS. 4A to 4D.

FIG. 4A shows the charge diffusion layer (CD) disposed to cover merely the side surfaces of the optical waveguide (WG). In this way, the potential of the side surfaces (+Z face, −Z face) of the convex section of the X-cut LN substrate may be canceled. Naturally, since the first electrode part (E1), which is a thin electrode, is in contact with the optical waveguide substrate 1, reduction in electric field efficiency can be suppressed.

In FIG. 4B, the charge diffusion layer (CD) is configured to cover the side surfaces of the optical waveguide (WG) and further extend slightly in a lateral direction (thin electrode direction). This provides margin in the case of left-right alignment deviation with respect to the optical waveguide during formation of the charge diffusion layer, and processing accuracy may be relaxed.

In the case of FIG. 4(a) and (b), the charge diffusion layer (CD) is not in contact with the electrodes (E1, E2) in the active section shown in the drawings, but by configuring the charge diffusion layer (CD) to contact the ground electrode (wiring part) in parts other than the active section, charges may also be efficiently released.

In FIG. 4C, as shown in a dotted line frame A, the charge diffusion layer (CD) is connected to the first electrode part (E1) which is a thin electrode. In this way, charges generated in the case of potential difference occurring at the side surfaces (+Z face, −Z face) of the convex section of the X-cut LN substrate may be released to the thick electrode (second electrode part E2) via the thin electrode (first electrode part E1).

In FIG. 4D, as shown in a dotted line frame B, the charge diffusion layer (CD) is connected to the second electrode part (E2) which is a thick electrode. More specifically, the thick electrode (second electrode part E2) is disposed to cover the buffer layer (BF) and charge diffusion layer (CD) disposed on the thin electrode (first electrode part E1). Therefore, the charge diffusion layer (CD) has a configuration that goes under between the electrodes. In this way, by widening the connection width of the charge diffusion layer to the thick electrode, there is margin for left-right alignment deviation during formation of the charge diffusion layer (CD), and processing accuracy may be relaxed. Also, electrical connection between the charge diffusion layer (CD) and the electrode may be more reliably performed.

As shown in FIG. 4(a) to (d), by having the first electrode part (E1) cover other convex sections (convex sections that do not form optical waveguides) 11 adjacent to the optical waveguide (WG), charges generated at the side surfaces (+Z face, −Z face) of the convex sections may be released. Also, as shown in FIGS. 4C and 4D, by covering the first electrode part (E1) with the charge diffusion layer (CD), charges may be effectively released.

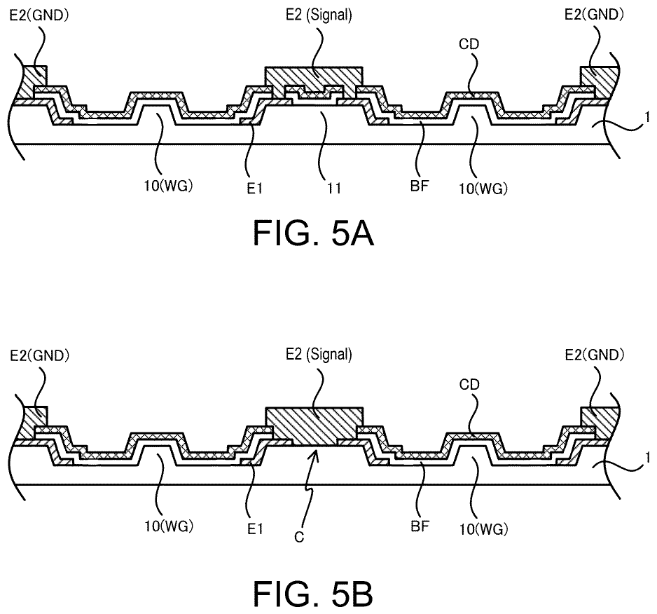

Next, as shown in FIG. 5A, a case of disposing the charge diffusion layer (CD) with respect to an RF modulation section that includes a signal electrode E2 (Signal) and a ground electrode E2 (GND) constituting a modulation electrode will be described.

Naturally, also in the RF modulation section, similar to the DC modulation section that includes DC bias electrodes, by disposing the charge diffusion layer, charge-up generated in the RF modulation section may be suppressed.

However, by disposing the charge diffusion layer in the RF modulation section, dielectric loss may increase and high frequency characteristics may deteriorate. Therefore, from the viewpoint of improving high frequency characteristics, it is preferable to narrow the disposition area of the charge diffusion layer (CD) or not dispose the charge diffusion layer (CD).

Furthermore, as shown in FIG. 5B, by not disposing the charge diffusion layer at the portion in which the second electrode part (E2) which is a thick electrode connects to the optical waveguide substrate 1, there is no formation that blocks the electric field, and the electric field from the signal electrode E2 (Signal) to the ground electrode E2 (GND) can be efficiently applied.

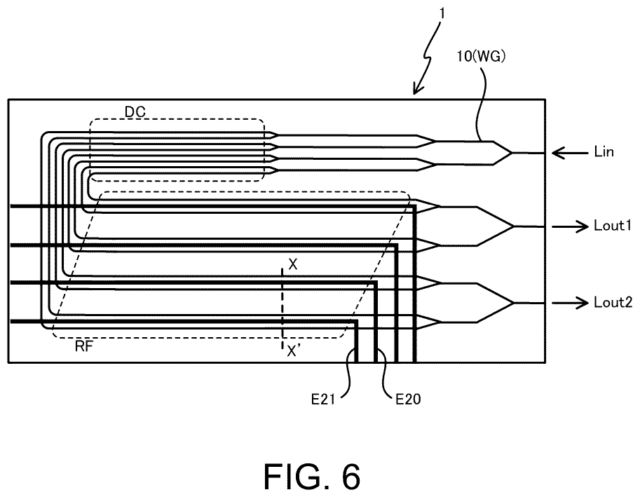

FIG. 6 is a plan view of the optical waveguide substrate 1, showing an example of the optical waveguide (WG). Input light Lin is branched and introduced into four parallel Mach-Zehnder optical waveguides, and then partially combined and emitted as output light (Lout1, Lout2).

In FIG. 6, the part constituted by modulation electrodes (RF modulation section) is shown by a dotted line frame RF, and the part constituted by DC bias electrodes (DC modulation section) is shown by a dotted line frame DC.

The size of the region in which the charge diffusion layer is formed in each of active sections shown by the RF modulation section and the DC modulation section will be examined. Also, since electrodes are also disposed in each of the active sections, the area of the region in which the charge diffusion layer is formed with respect to the part excluding the area occupied by the electrodes of the active section will also be examined. More specifically, locally, it is the area of the part sandwiched between opposing electrodes, and overall, it is the sum of the areas sandwiched between respective electrodes.

In the DC modulation section, the ratio of the area occupied by the charge diffusion layer is set to 70% or more, preferably 80% or more, more preferably 100% (entire surface). This improves charge diffusion efficiency over a wide range of the DC modulation section. Since drift phenomenon is likely to occur in the DC modulation section, it is preferable to dispose the charge diffusion layer over a wide range.

In contrast, in the RF modulation section, the presence of the charge diffusion layer deteriorates high frequency characteristics. Therefore, in the RF modulation section, it is preferable to minimize the disposition of the charge diffusion layer. Also, focusing on the surface of the optical waveguide substrate 1 including the RF modulation section and DC modulation section as shown in FIG. 6 (however, the surface excluding the electrode disposition parts), from the viewpoint of suppressing the generation of film stress by the charge diffusion layer, the occupied area of the charge diffusion layer is suppressed to 80% or less, preferably 70% or less, more preferably 50% or less of the entire device.

Next, as shown in FIG. 6, in the case where the optical waveguide (WG) includes multiple Mach-Zehnder optical waveguides, a method for mitigating the generation of internal stress between the respective Mach-Zehnder optical waveguides due to film bodies such as electrodes and charge diffusion layers will be described.

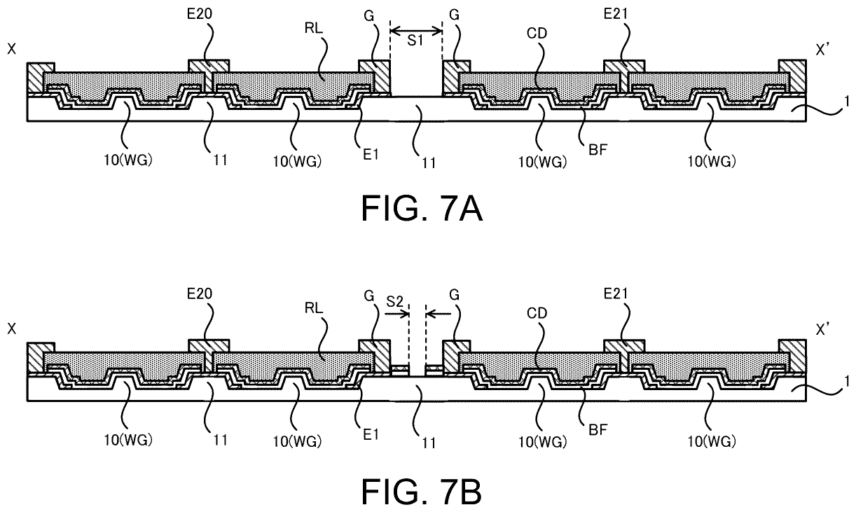

FIGS. 7A and 7B are cross-sectional views taken along a dashed-dotted line X-X′ in FIG. 6. Reference numerals E20 and E21 are signal electrodes constituting modulation electrodes.

In FIG. 7A, regarding the two ground electrodes G between adjacent Mach-Zehnder optical waveguides, a gap S1 is provided to partially expose the surface of the optical waveguide substrate 1.

Also, in FIG. 7B, a gap S2 is provided in a part of the buffer layer (BF) and charge diffusion layer (CD) between adjacent Mach-Zehnder optical waveguides to expose a part of the surface of the optical waveguide substrate 1.

In this way, by providing a portion in which the surface of the optical waveguide substrate is exposed in at least a part between the adjacent Mach-Zehnder optical waveguides, the internal stress generated by the film body may be divided.

The size of the gap S1 or gap S2 is 3 μm or more, preferably 5 μm or more, more preferably 10 μm or more.

Also, in regions in which charge diffusion layers are formed, such as the DC modulation section in FIG. 6, it is effective to expose the surface of the optical waveguide substrate longer than the optical waveguide (WG) located in the active section.

Even in the portion at which the optical waveguide substrate 1 is exposed, a film body that does not affect film stress, such as a thin buffer layer or resin layer may be disposed.

Next, an example in which the optical waveguide device of the disclosure is applied to an optical modulation device or optical transmission apparatus such as a High Bandwidth Coherent Driver Modulator (HB-CDM) will be described. In the following, description will be made using an example of HB-CDM, but the disclosure is not limited thereto and is also applicable to optical phase modulators, optical modulators having polarization combining functions, optical waveguide devices integrating more or fewer Mach-Zehnder optical waveguides, bonding devices with optical waveguide devices composed of other materials such as silicon, devices for sensor applications, and the like.

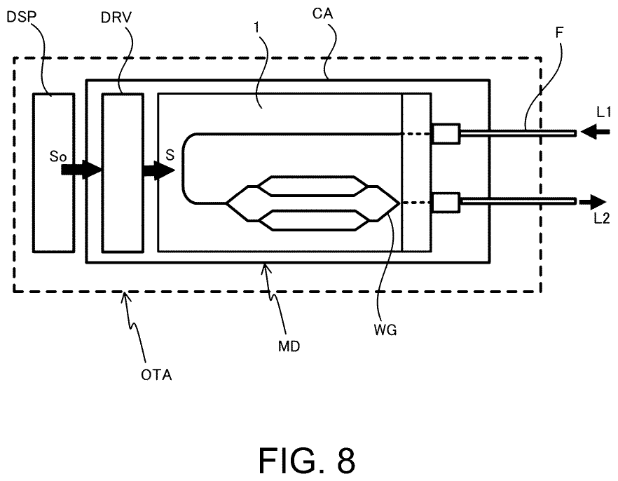

As shown in FIG. 8, the optical waveguide device is accommodated in a housing CA. Furthermore, by providing an optical fiber (F) that inputs and outputs a light wave to the optical waveguide (WG), an optical modulation device MD can be configured.

In FIG. 8, the optical fiber F is introduced into the housing through a through-hole penetrating the side wall of the housing CA, and the optical component or substrate is directly bonded to the optical fiber. Without being limited thereto, the optical fiber and the optical waveguide device may be optically coupled via an optical block equipped with an optical lens optically coupled to the optical waveguide in the optical waveguide device, a lens barrel, a polarization multiplexing section, or the like. Also, in order to stably perform bonding with the optical fiber or optical block, reinforcing members may be disposed in an overlapping manner along the end face of the optical waveguide substrate.

An optical transmission apparatus OTA can be configured by connecting an electronic circuit (digital signal processor DSP) that outputs a modulation signal So for causing the optical modulation device MD to perform modulation operation to the optical modulation device MD. In order to obtain a modulation signal S to be applied to the optical waveguide device, it is needed to amplify the modulation signal So output from the digital signal processor DSP. Therefore, in FIG. 8, a driver circuit DRV is used to amplify the modulation signal. The driver circuit DRV and the digital signal processor DSP can be disposed outside the housing CA, but can also be disposed inside the housing CA. In particular, by disposing the driver circuit DRV inside the housing, propagation loss of the modulation signal from the driver circuit may be further reduced.

The optical modulation device described above has been described in a state incorporated in a housing, but the optical waveguide device and each of components, which are subassembly products at a stage before being incorporated in the housing, are also included in the optical modulation device of the disclosure.

Also, the modulation electrode of the above optical waveguide device exemplifies a single modulation signal, but it goes without saying that the disclosure can also be applied to a differential electrode configuration using differential signals, without being limited thereto.

Furthermore, although it has been shown that the first or second electrode part is formed as one electrode layer, the first or second electrode part may also be configured with a combination of multiple electrode layers.

As described above, according to the disclosure, an optical waveguide device that achieves both improvement of electric field efficiency and suppression of the pyroelectric effect may be provided. Furthermore, an optical modulation device and an optical transmission apparatus using such an optical waveguide device can be provided.

What is claimed is:

1. An optical waveguide device composed of a ferroelectric material, comprising:
an optical waveguide substrate, having an optical waveguide; and control electrodes that apply an electric field to the optical waveguide, wherein
the optical waveguide is formed in a part of a convex section formed on a surface of the optical waveguide substrate,
a buffer layer and a charge diffusion layer that cover the optical waveguide are formed in order, and
the control electrodes are disposed in contact with the optical waveguide substrate.

2. The optical waveguide device according to claim 1, wherein
the buffer layer and the charge diffusion layer that cover the optical waveguide are disposed so as to cover at least a part of the control electrode.

3. The optical waveguide device according to claim 1, wherein
the control electrode is disposed on another convex section adjacent to the optical waveguide.

4. The optical waveguide device according to claim 1, wherein
the control electrode is composed of a first electrode part having a thin thickness and a second electrode part having a thick thickness.

5. The optical waveguide device according to claim 1, wherein
a resin layer covering at least a part of the charge diffusion layer is formed.

6. The optical waveguide device according to claim 1, wherein
the optical waveguide comprises a plurality of Mach-Zehnder optical waveguides, and
at least a part between the adjacent Mach-Zehnder optical waveguides has a portion in which the surface of the optical waveguide substrate is exposed.

7. The optical waveguide device according to claim 1, wherein
a thickness of the charge diffusion layer is set within a range of 50 nm or more and 500 nm or less.

8. The optical waveguide device according to claim 1, wherein
a thickness of the buffer layer is set within a range of 200 nm or more and 3000 nm or less.

9. The optical waveguide device according to claim 1, wherein
a volume resistivity of the charge diffusion layer is set within a range of 10⁸ Ω·cm or more and 10¹⁴ Ω·cm or less.

10. An optical modulation device, comprising:
the optical waveguide device according to claim 1, accommodated in a housing; and
an optical fiber, inputting or outputting a light wave to the optical waveguide.

11. The optical modulation device according to claim 10, wherein
the optical waveguide device has a modulation electrode for modulating a light wave propagating through the optical waveguide, and
an electronic circuit that amplifies a modulation signal input to the modulation electrode is provided inside the housing.

12. An optical transmission apparatus, comprising:
the optical modulation device according to claim 10; and
an electronic circuit, outputting a modulation signal to the optical modulation device.
